(19) United States
(12) Patent Application Publication
(10) Pub. No.: US 2024/0175108 A1
(43) Pub. Date: May 30, 2024

(54) 5000 SERIES ALUMINUM ALLOY PRODUCTS PRODUCED USING SOLID STATE MANUFACTURING

(71) Applicant: MELD MANUFACTURING CORPORATION, Christiansburg, VA (US)

(72) Inventors: Ryan Henderson, Christiansburg, VA (US); Mandana Meisami Azad, Christiansburg, VA (US); Chase Clear, Christiansburg, VA (US); Chase Cox, Christiansburg, VA (US); Jacob Yoder, Christiansburg, VA (US); Edward Colvin, Christiansburg, VA (US)

(21) Appl. No.: 18/380,574

(22) Filed: Oct. 16, 2023

Related U.S. Application Data
(60) Provisional application No. 63/416,760, filed on Oct. 17, 2022.

(51) Int. Cl. C22C 21/08; B22F 10/25; B22F 12/50; B22F 12/90; B33Y 10/00; B33Y 30/00; B33Y 80/00

(52) U.S. Cl. CPC C22C 21/08; B22F 10/25; B22F 12/50; B22F 12/90; B33Y 10/00; B33Y 30/00; B33Y 80/00

(57) ABSTRACT

Solid-state additive manufactured aluminum alloy products and methods of producing them are described. At least 60% percent by volume of the aluminum in the additive manufactured aluminum alloy product is present as equiaxed grains with aspect ratios less than 2:1. There is minimal void space between metal atoms of the additive manufactured aluminum alloy product. Various parts including 5000-type aluminum alloy products are described.

### PRIORITY APPLICATION

This application claims priority to and the benefit of U.S. Provisional Application No. 63/416,760 filed on Oct. 17, 2022, the entire disclosure of which is hereby incorporated herein by reference.

### TECHNOLOGICAL FIELD

Certain embodiments described herein are directed to aluminum alloy products. More particularly, certain configurations described are directed to aluminum alloy products produced using 5000 series or 5000-type aluminum alloy and solid state additive manufacturing.

### BACKGROUND

Metal parts are often produced using forging or extrusion processes. Forging and extrusion processes often require the use of expensive components to shape or produce the metal parts.

### SUMMARY

Certain aspects, embodiments, features and attributes of aluminum alloy products produced using solid state additive manufacturing components are described. The aluminum alloy products can have similar or better properties than forged or extruded products. Large and complex parts can be produced using the aluminum alloy.

In an aspect, a solid-state additive manufactured aluminum alloy product is described. In certain configurations, at least 60% percent by volume of the aluminum in the additive manufactured aluminum alloy product are present as equiaxed grains, with aspect ratios less than 2:1, in the additive manufactured aluminum alloy product. In some embodiments, there is minimal void space between metal atoms of the additive manufactured aluminum alloy product. In certain examples, the solid-state additive manufactured aluminum product comprises a 5000-type aluminum alloy material.

In some configurations, the solid-state additive manufactured aluminum alloy product comprises an ultimate tensile strength of at least 310 MPa, a yield strength of at least 276 MPa, and an elongation at break of 12%.

In some embodiments, the solid-state additive manufactured aluminum alloy product comprises a single track of deposited solid-state additive manufactured aluminum alloy product.

In other embodiments, the solid-state additive manufactured aluminum alloy product comprises a plurality of overlapping tracks of deposited solid-state additive manufactured aluminum alloy product. In some examples, adjacent tracks overlap by at least 10%.

In certain configurations, the solid-state additive manufactured aluminum alloy product comprises a substrate that receives the solid-state additive manufactured aluminum alloy product.

In other embodiments, at least 75% percent by volume of the aluminum in the additive manufactured aluminum alloy product are present as equiaxed grains. In some embodiments, at least 90% percent by volume of the aluminum in the additive manufactured aluminum alloy product are present as equiaxed grains.

In another aspect, a solid state additive manufactured aluminum alloy produced by adding an aluminum alloy to a surface of a substrate using a solid state additive manufacturing process is disclosed. In some configurations, the aluminum alloy is added in a solid state as a first aluminum alloy layer to the surface of the substrate at a first tool temperature between 290 degrees Celsius to 500 degrees Celsius and then optionally heat treated, annealed, etc. In some examples, at least 60% percent by volume of aluminum in the added, first aluminum alloy layer are present as equiaxed grains, with aspect ratios less than 2:1, and wherein there is minimal void space between metal atoms in the added, first aluminum alloy layer. In certain examples, the solid-state additive manufactured aluminum product comprises a 5000-type aluminum alloy material.

In some examples, the solid-state additive manufactured aluminum alloy comprises an ultimate tensile strength of at least 310 MPa, a yield strength of at least 276 MPa, and an elongation at break of 12%.

In certain embodiments, the solid-state additive manufactured aluminum alloy comprises a single track of deposited solid-state additive manufactured aluminum alloy. In other embodiments, the solid-state additive manufactured aluminum alloy comprises a plurality of overlapping tracks of deposited solid-state additive manufactured aluminum alloy. In some instances, adjacent tracks overlap by at least 10%.

In some embodiments, the solid-state additive manufactured aluminum alloy comprises a substrate that receives the solid-state additive manufactured aluminum alloy.

In other embodiments, at least 75% percent by volume of the aluminum in the additive manufactured aluminum alloy are present as equiaxed grains. In some embodiments, at least 90% percent by volume of the aluminum in the additive manufactured aluminum alloy are present as equiaxed grains.

In an additional aspect, an additive manufacturing system for producing an aluminum alloy product is described. In certain configurations, the additive manufacturing system comprises a feeding unit, a spindle, a tool, a temperature sensor and a processor. The feeding unit can be configured to receive an aluminum alloy filler material. The spindle comprises an internal path configured to receive the aluminum alloy filler material from the feeding unit. The tool is coupled to the spindle and is configured to receive the aluminum alloy filler material from the spindle and add the received aluminum alloy filler material to a surface of a substrate in a solid state as a first aluminum alloy layer. The temperature sensor is configured to measure a temperature of the tool during addition of the aluminum alloy filler material as the first aluminum alloy layer to the surface of the workpiece. The processor is electrically coupled to the temperature sensor and the spindle and optionally other components. The system can also include a computer readable medium electrically coupled to the processor. The computer readable medium comprises instructions stored thereon, wherein the instructions, when executed by the processor, cause the processor to control movement of the spindle to control a first tool temperature of the tool between 290 degrees Celsius to 500 degrees Celsius during addition of the first aluminum alloy layer to the surface of the substrate. The added first aluminum alloy layer comprises at least 60% percent by volume of aluminum as equiaxed grains, with aspect ratios less than 2:1, wherein there is minimal void space between metal atoms in the added, first aluminum alloy layer. The added, first aluminum alloy layer comprises a 5000-type aluminum alloy material.

In certain embodiments, the processor is configured to increase a temperature of the tool from the first tool temperature to a second tool temperature about 20 degrees Celsius higher than the first tool temperature to add a vertical layer of the aluminum alloy to the added first aluminum alloy layer.

In some embodiments, the tool comprises tool steel, copper, a copper alloy, tungsten or a tungsten alloy. In other embodiments, the tool comprises at least one nub. In some examples, the feeding unit comprises an actuator to force the aluminum alloy filler material into the spindle and the tool.

In another aspect, a method of producing an additive manufactured aluminum alloy is provided. In certain embodiments, the method comprises adding an aluminum alloy as a first aluminum alloy layer to a surface of a substrate using an additive manufacturing process comprising a rotating tool, wherein the aluminum alloy is added to the surface of the workpiece in a solid state at a first tool temperature. In other embodiments, the added first aluminum alloy layer comprises at least 60% percent by volume of aluminum as equiaxed grains, with aspect ratios less than 2:1, wherein there is minimal void space between metal atoms in the added, first aluminum alloy layer, and wherein the added, first aluminum alloy layer comprises a 5000-type aluminum alloy material. In some embodiments, the first tool temperature is between 290 degrees Celsius to 500 degrees Celsius.

In other embodiments, the first tool temperature is maintained by one or more of: varying a speed of a spindle coupled to the rotating tool; or varying torque of the spindle coupled to the rotating tool; or varying power of the spindle coupled to the rotating tool; or varying a deposition rate of the added aluminum alloy; or varying a traverse rate of the rotating tool; or varying a filler feed rate into the rotating tool; or varying a layer height; or varying a filler force; or varying a pressure under the rotating tool; or using an external heating/cooling source adjacent to the rotating tool; or using an external heating/cooling source adjacent to the surface of the substrate; or varying a tool geometry during addition.

In some embodiments, the method comprises adding a second aluminum alloy layer in the solid state to the added, first aluminum alloy layer using the rotating tool, wherein the second aluminum alloy layer is added using a second tool temperature that is 20 degrees Celsius higher than the first tool temperature. In certain embodiments, the added second aluminum alloy layer comprises at least 60% percent by volume of aluminum as equiaxed grains, with aspect ratios less than 2:1, wherein there is minimal void space between metal atoms in the added, second aluminum alloy layer, and wherein the added, second aluminum alloy layer comprises a 5000-type aluminum alloy material.

In another aspect, a subtractive and additive method of producing an aluminum alloy comprises adding an aluminum alloy as a first aluminum alloy layer to a surface of a substrate using an additive manufacturing process comprising a rotating tool, wherein the aluminum alloy is added to the surface of the workpiece in a solid state at a first tool temperature, removing a portion of the added first aluminum alloy layer using a subtractive process to provide a subtracted first aluminum alloy layer on the substrate; and optionally heat treating or annealing the subtracted first aluminum alloy layer, wherein the subtracted first aluminum alloy layer comprises at least 60% percent by volume of aluminum as equiaxed grains, with aspect ratios less than 2:1, wherein there is minimal void space between metal atoms in the subtracted, first aluminum alloy layer, and wherein the subtracted, aluminum alloy layer comprises a 5000-type aluminum alloy material. In certain configurations, the first tool temperature is between 290 degrees Celsius to 500 degrees Celsius. In some embodiments, the first tool temperature is maintained by one or more of: varying a speed of a spindle coupled to the rotating tool; or varying torque of the spindle coupled to the rotating tool; or varying power of the spindle coupled to the rotating tool; or varying a deposition rate of the added aluminum alloy; or varying a traverse rate of the rotating tool; or varying a filler feed rate into the rotating tool; or varying a layer height; or varying a filler force; or varying a pressure under the rotating tool; or using an external heating/cooling source adjacent to the rotating tool; or using an external heating/cooling source adjacent to the surface of the substrate; or varying a tool geometry during addition.

In some embodiments, the method comprises adding a second aluminum alloy layer in the solid state to the subtracted, aluminum alloy layer using the rotating tool, wherein the second aluminum alloy layer is added using a second tool temperature that is 20 degrees Celsius higher than the first tool temperature. In certain embodiments, the added, second aluminum alloy layer comprises at least 60% percent by volume of aluminum as equiaxed grains, with aspect ratios less than 2:1, wherein there is minimal void space between metal atoms in the added, second aluminum alloy layer, and wherein the added, second aluminum alloy layer comprises a 5000-type aluminum alloy material.

Additional aspects, embodiments, configurations and features are described in more detail below.

### BRIEF DESCRIPTION OF THE SEVERAL VIEWS OF THE DRAWINGS

Certain aspects are described in more detail below which refer to the accompanying drawings in which:

FIG. 1 is an illustration of certain components of a solid state additive manufacturing system including a feeding unit, a spindle and a tool, in accordance with certain embodiments;

FIG. 2 is an illustration showing a feeding unit, a spindle, a tool and certain other components of a solid state additive manufacturing system, in accordance with certain embodiments;

FIG. 3 is another illustration showing a feeding unit, a spindle, a tool and certain other components of a solid state additive manufacturing system, in accordance with certain embodiments;

FIG. 4 is an additional illustration showing a feeding unit, a spindle, a tool and certain other components of a solid state additive manufacturing system, in accordance with certain embodiments;

FIG. 5 is an illustration showing a tool including surface features, in accordance with certain embodiments;

FIG. 6 is an illustration showing a temperature sensor positioned within or adjacent to a tool, in accordance with certain embodiments;

FIG. 7 is an illustration showing various components of a control system including a processor that can be used to control operation of the various components in a solid state additive manufacturing system, in accordance with certain embodiments;

FIG. 8 is an illustration showing a combined additive manufacturing system and a subtractive system, in accordance with certain embodiments;

FIG. 9 is an illustration of a truck trailer, in accordance with certain embodiments;

FIG. 10 is an illustration of a boat hull, in accordance with certain embodiments;

FIG. 11 is an illustration of a rail car, in accordance with certain embodiments;

FIG. 12 is an illustration of a liquefied natural gas (LNG) tank, in accordance with certain embodiments; and

FIG. 13 is an illustration of a ship deck, in accordance with certain embodiments;

FIG. 14 is an illustration of a fuel tank, in accordance with certain embodiments;

FIG. 15 is an illustration of a tie down, in accordance with certain embodiments;

FIG. 16 is an illustration showing equiaxed grains that can be produced from depositing a 5000-type aluminum alloy using a solid state additive manufacturing system.

FIG. 17 is an illustration showing a crack in an aluminum deck, in accordance with certain embodiments;

FIG. 18 is an illustration showing material added into the crack of FIG. 17, in accordance with certain embodiments; and

FIG. 19 is a photograph showing deposited 5083 alloy material into the crack of FIG. 17, in accordance with certain embodiments.

### DETAILED DESCRIPTION

Certain embodiments described herein use a 5000-type aluminum alloy in combination with solid state additive manufacturing to produce products and articles including the 5000-type aluminum alloy. The exact composition of the 5000-type alloy can vary and includes, for example, 5083, 5052, 5456, 5183 and 5182 aluminum alloys. The 5000-type alloy may be referred to in certain instances as 5xxx-series alloy. The exact amounts of various materials may vary from alloy to alloy. As illustrations, the 5083 alloy generally includes a composition of 4.0-4.9 weight percent magnesium, 0.4-1 weight percent manganese, less than or equal to 0.4 weight percent of each of iron and silicon and less than or equal to 0.25 weight percent of each of copper, silicon, titanium and zinc with the remainder being aluminum and incidental impurities to sum to 100 weight percent. 5083 alloys generally can provide parts having an ultimate tensile strength of at least 345 MPa, a yield tensile strength of at least 270 MPa and an elongation at break of 9%. The 5052 alloy includes a composition of 0.15-0.35 weight percent chromium, 2.2-2.8 weight percent magnesium, less than or equal to 0.4 weight percent iron, less than or equal to 0.25 weight percent of each of copper, manganese, silicon and zinc with the remainder being aluminum and incidental impurities to sum to 100 weight percent. 5052 alloys generally can provide parts having an ultimate tensile strength of at least 225 MPa, a yield tensile strength of at least 190 MPa and an elongation at break of at least 12%, e.g., at least 18%. The 5456 alloy includes a composition of 4.7-5.5 weight percent magnesium, 0.5 to 1 weight percent manganese, less than or equal to 0.4 weight percent iron, less than or equal to 0.25 weight percent of each of chromium, copper, silicon, titanium and zinc with the remainder being aluminum and incidental impurities to sum to 100 weight percent. 5456 alloys generally can provide parts having an ultimate tensile strength of at least 310 MPa, a yield tensile strength of at least 155 MPa, and an elongation of at least 15%. The 5183 alloy includes a composition of 4.3-5.2 weight percent magnesium. 0.5-1 weight percent manganese, less than or equal to 0.4 weight percent of each of silicon and iron, and less than 0.25 weight percent of each of copper, chromium, zinc, and titanium with the remainder being aluminum and incidental impurities to sum to 100 weight percent. 5183 alloys generally can provide parts having an ultimate tensile strength of at least 280 MPa, a yield tensile strength of at least 140 MPa and an elongation of at least 15%. The 5182 alloy includes a composition of 4-5 weight percent magnesium, 0.2-0.5 weight percent manganese, less than or equal to 0.35 weight percent iron, and less than or equal to 0.25 weight percent of each of copper, chromium, zinc, and titanium with the remainder being aluminum and incidental impurities to sum to 100 weight percent. 5182 alloys generally can provide parts having an ultimate tensile strength of at least 255 MPa, a yield tensile strength of 110 MPa, and an elongation of 11%. Unless specified otherwise in the text below, reference to “the alloy” refers to the 5000-type aluminum alloy. In certain configurations, the 5000-type aluminum alloys are generally considered non-heat treatable alloys, but the alloys can still be tempered through annealing and/or rolling operations.

In certain examples, the 5000-type aluminum alloys provide excellent resistance to corrosion caused by salts, e.g., in seawater, and are often used in marine and wet applications. For example, 5000-type aluminum alloys are often used to produce ladders, docks, decking, truck trailer, automotive sheet, packaging, beverage can, boat hulls, boat decks, LNG tanks, rail car, coal cars, grain cars, fuel tankers, building and construction, heat exchangers, chemical process, and industrial applications.

In certain configurations, the various alloys described herein can be used in bar form, sheet form, pellets, rods, squares, square rods or other forms in solid state additive manufacturing to produce products and articles which include the alloy. For example, bar stock alloy can be added to a solid state additive (SSA) manufacturing system and used to provide a large article that includes the alloy. In general, solid state additive manufacturing produces parts and articles which have similar or better properties than existing processes such as die forging, but with much lower cost and material usage. The (SSA) manufacturing does not require dedicated forging tooling which is very expensive and time consuming to design and build. Often lead times for new forging designs are six months and can be over one year. The cost of such tooling varies depending on the size and complexity of the design but is frequently several hundred thousand dollars or even more. The equipment required for the forging operations is very expensive and expansions to add capacity can take years from approval to qualification.

### SSA System Components

In some examples, the SSA manufacturing system may use a friction stir additive process to build parts using a solid-state method that can produce large three-dimensional shapes without melting and resolidifying the metal and without expensive tooling. Compared to casting, the properties and metal integrity (density, constituent particles, voids) are much better for the SSA manufacturing process. Unlike forging, no expensive tooling is required which not only saves money, but also reduces lead time to produce parts. Compared to machined plate, much thicker parts can be produced as plate is limited to approximate 200 mm high walls and even that uses 200 mm thick plate which has significantly reduced strength because of the slow quench for thick products. The SSA manufacturing process allows the parts to be tailored and designed in ways that are not possible for forgings because there are few limitations on geometry. For example, walls become closer together as they are deposited making shapes like enclosed cones possible. The resulting articles can have similar properties as plates and forgings.

In certain configurations, the exact process steps used in SSA manufacturing can vary as noted in detail below. In general and without intended to limit the particular process steps and conditions that can be used, the manufacturing process starts with a substrate, usually plate, but can be other product forms such as extrusions and forgings, then involves layer-by-layer building of parts in either single walls for thinner sections, or multiple, overlapping walls for thicker sections. By moving the depositing spindle relative to a reference point, the 3D parts are built up with selected geometries. The process controls deposition within careful parameters including external heat/cooling, deposition rate, rotational frequency, and spindle travel while monitoring temperature and using temperature feedback to affect the other parameters to achieve excellent adhesion and metallurgical bonding between each layer and overlap. As noted herein, the resulting product or article can include a major amount by volume, i.e., greater than 50% by volume, of equiaxed grains. The material that is added to the substrate in solid form is typically non-heat treated alloy which can then be heat treated/aged post-deposition to provide a desired temper. The material can be removed from the substrate post-deposition, or the substrate may remain in contact with the added material and used to form the final part.

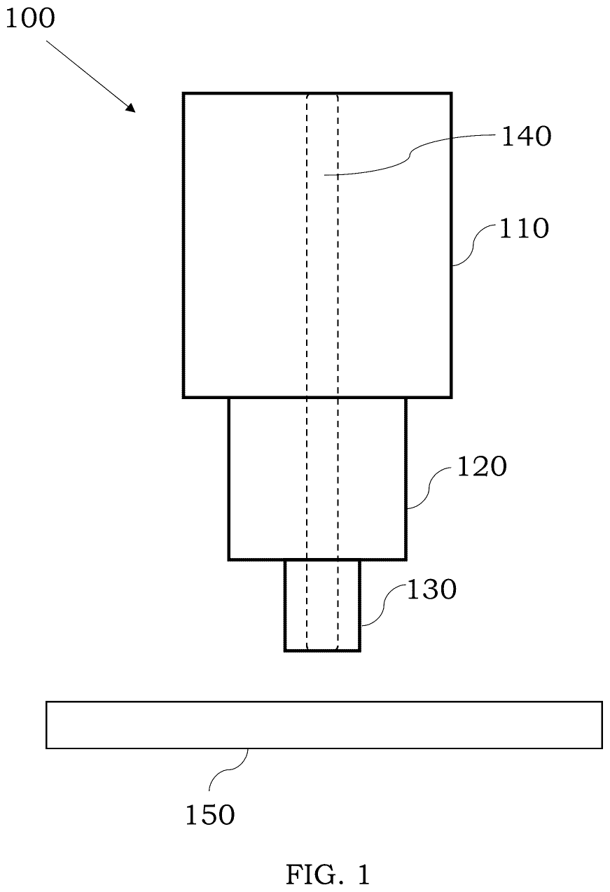

In certain embodiments, a schematic of various components of a solid state additive manufacturing system is shown in FIG. 1. The system 100 includes a feeding unit 110, spindle 120, and a tool 130. A passageway (throat) for the alloy filler material (feedstock) 140 is shown. The system 100 can include other components as noted below. A substrate 150 is shown that receives the printed alloy material from the tool 130. The alloy material can be fed into the throat 140 from the feeding unit 110 at a desired rate as noted below. For example, a piston or rod can be used to push the alloy feedstock material toward a surface of the substrate 150. The spindle 120 is generally coupled to a motor (not shown) to rotate the spindle 120 and tooling 130 at a desired rotational speed. The tooling 130 is placed adjacent to the substrate 150 and deposits the alloy material in the throat onto the surface of the substrate 150 in solid form. As noted in more detail below, the tooling 130 can include surface features and/or certain geometries to assist in deposition of the alloy material onto the surface of the substrate 150. Friction-based fabrication tooling 130 generally comprises a non-consumable body formed from material capable of resisting deformation when subjected to frictional heating and compressive loading at the surface of the substrate 150. As the spindle 120 and tooling 130 rotate, a thin layer or track of the alloy material is deposited onto the surface of the substrate 150. The deposition temperature can be tightly controlled to impart a desired microstructure, and correspond Ly provide desired deposited alloy material properties, to the deposited material after heat treatment. As described in more detail below, the deposition temperature may be lower during initial deposition of alloy material onto the substrate 150 and can be increased during addition of successive layers/walls/tracks to provide a desired metallurgical bond between the multiple walls/layers/tracks. The exact temperature difference can vary depending on the particular alloy that is used, and illustrative deposition temperatures are described in more detail below.

In certain embodiments, the system 100 can include suitable platforms, motors or other components to permit the substrate 150 to move independently of the spindle 120 and the tooling 130. For example, each of the substrate 150 and the tooling 130 can independently be moved in x-, y-, and z-directions. This independent movement provides for production of complex geometric shapes, varying thicknesses across the surface of the produced part and permits for enhanced control of the various components during deposition of the alloy feedstock material onto a surface of the substrate 150.

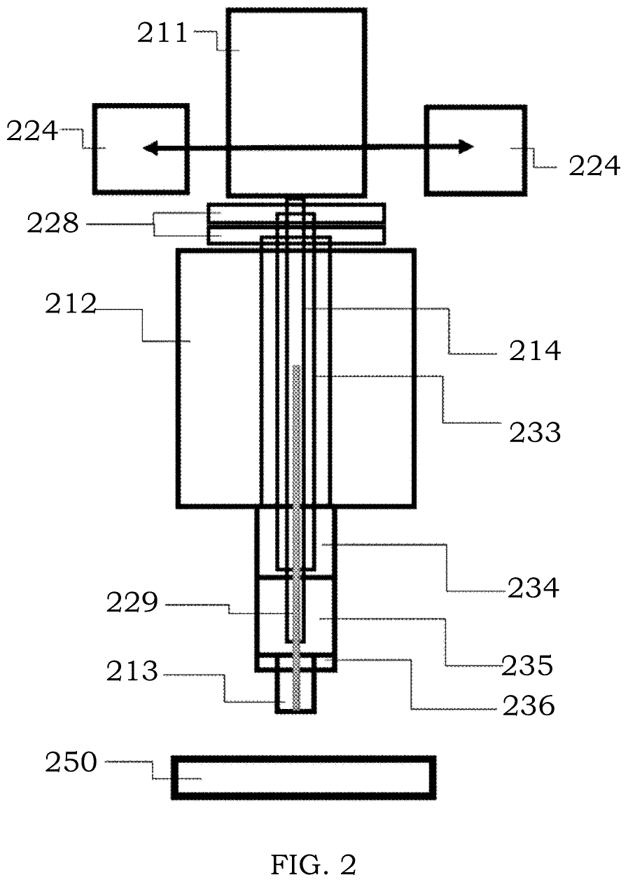

In certain configurations, the feeding unit of the system 100 generally comprises a reservoir configured to receive the alloy feedstock material. The exact shape and configuration of the reservoir may vary depending on the particular form of the alloy feedstock material to be used. The alloy feedstock material can be fed in a continuous or non-continuous manner as desired. An illustration of certain components of a feeding unit configured to feed continuous solid rod or solid rod-like alloy material is shown in FIG. 2. The feeding unit 211 is shown being placed in communication with a spindle 212 and a tool 213. A throat or operational passageway 214 is shown along with a substrate 250 that can receive the alloy filler material. Other system components, such as the motors 224, drive pulleys 228 for spindle 212, alloy rod filler material 229, secondary spindle, which is floating (non-driven) 233, lower spindle 234, tool holder 235 and a pressure plate 236 are shown as well.

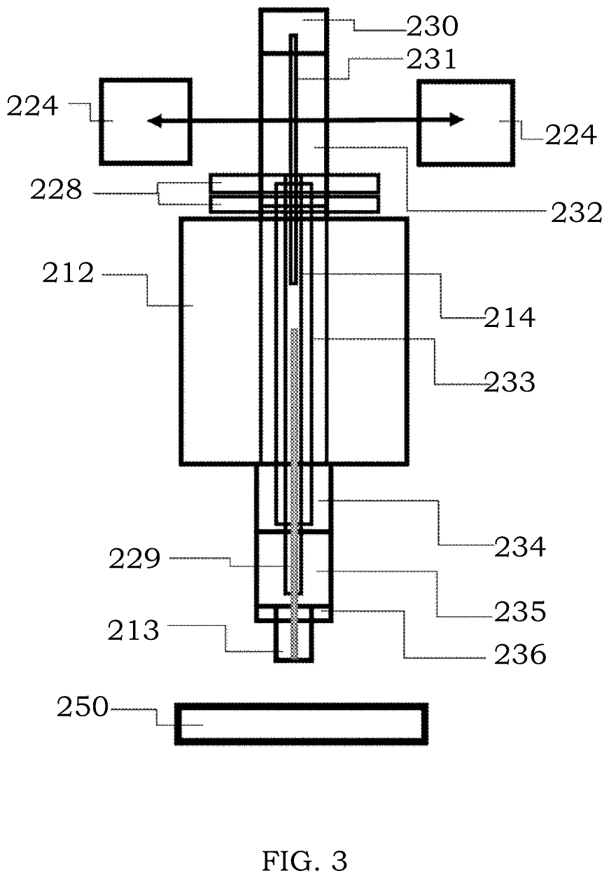

Another illustration of a feeding unit is shown in FIG. 3. This feeding unit shown in FIG. 3 can be used to feed discontinuous solid alloy filler material, which can be in the form of rods, squares or other shapes. The illustration in FIG. 3 shows the spindle 212 and the tool 223 with operational passageway 204 and the workpiece 250. Other system components, such as the motors 224, drive pulleys 218 for spindle 212, rod filler material 229, actuator-downward force driver 230, push rod 231, solid feed push-rod and actuator stand with bearings 232, secondary spindle, which is floating (non-driven) 233, lower spindle 234, tool holder 235 and a pressure plate 236. In certain embodiments, the feeding unit can include and use an actuator 230, a push rod 231, two guide rods and cross member, wherein the actuator creates a downwards force to push the alloy feedstock material through the throat 214 and onto the substrate. The guide rods and cross member are optional and can be present for stabilizing the push rod 231.

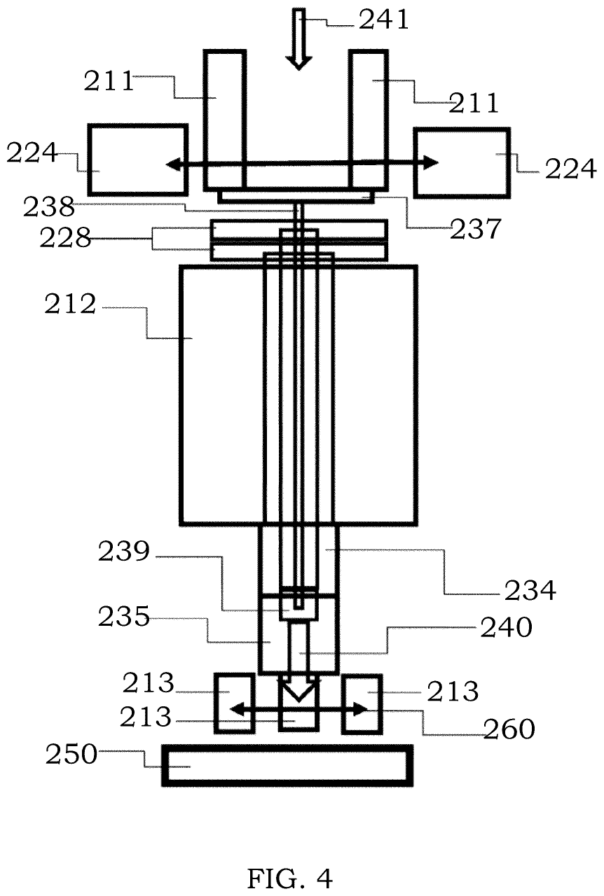

Another illustration of a feeding unit is shown in FIG. 4. This feeding unit shown in FIG. 4 can be used to feed powder, particle or pellet type alloy filler material. Shown in cross-section in FIG. 4 are a feeding unit 211, spindle 212 and tools 213 with operational passageway 214 and a substrate 250 that can receive the powder- or pellet-like filler alloy material from the tool 213. Other system components, such as the motors 224, drive pulleys 228 for the spindle 212, secondary spindle, which is floating (non-driven) 233, lower spindle 234, tool holder 235, pressure plate 236, lateral delivery system 237, mixing downtube 238, auger drive mechanism 239, auger assembly 240 and optional injection ports for liquid additives (e.g. lubricants, catalysts, etc.) 241 are shown. A tool changer 260 is also shown and discussed in more detail below.

While the illustrative feeding units shown in FIGS. 2-4 are configured to provide different types of alloy filler material to an underlying substrate, combinations of different alloy filler can also be present in a feeding unit and provided to the tooling for deposition on a substrate. The tool holder 235 with throat is capable to hold and rotate the tool, and the throat allows alloy feedstock material to be provided from the feeding unit to the substrate.

In certain embodiments, a tool changer 260 can be present to enable change of one or multiple different tools; For example, the tool changer 260 can permit changing one tool with the same tool for the purpose of replacing a worn tool of the same type, or a different tool with the purpose to impart a different functionality in the deposited layer during the deposition process can be changed. A tool changer 260 is optional and may be omitted if desired. The tool changer 260 can comprise a variety of tools disposed in dormant positions (e.g., waiting to be used) and can comprise a mechanism for automatically or manually positioning a selected tool into an active position (e.g., where the tool can actively be used). For example, different tools can be used to deposit a first track and additional tracks on the first track. Alternatively, different tools can be used to deposit different shapes or geometries onto the substrate.

The SSA manufacturing systems described herein advantageously use tool or tooling which is non-consumable and is configured to deposit the alloy feedstock material onto a substrate. The tool or tooling can be configured to exert frictional and other forces on the alloy feedstock material for imparting rotation to the alloy feedstock material from the body of the tool when rotated at a speed sufficient for imposing frictional heating of the alloy feedstock material against a substrate. As described in more detail below, the tool generally comprises a body with a throat which is in communication with the feeding unit to receive material from the feeding unit. The body is designed to deposit the received ally feedstock material from the throat onto the substrate. The body can be configured with one or more surface features constructed and arranged to trap deposited alloy material loaded on the substrate in a space or volume between the body and the substrate. The trapped material can be subjected to forming and/or shearing forces to deposit the alloy material in solid form onto a surface of the substrate.

In certain embodiments, the tool or tooling can be produced using materials with a higher hardness than the alloy material to be deposited and harder than the substrate. For example, the tool or tooling may comprise tool steel, copper and copper alloy materials, tungsten or tungsten alloy materials, and other metals which in pure or alloy form have a higher Vickers hardness than the alloy to be deposited and the substrate material. By selecting a higher hardness for the tooling material, the tooling generally is not consumed or deformed during the deposition process and can be used to provide multiple tracks on the substrate without the need to change the tool.

Various interior geometries for the tooling are possible. With a non-circular geometry, the consumable filler material can rotate at the same angular velocity as the non-consumable portion of the tool due to normal forces being exerted by the tool at the surface of the tool throat against the feedstock. Such geometries include a square through-hole and an elliptical through-hole as examples. In configurations where only exertion of tangential forces on the surface of the alloy filler material by the internal surface of the throat of the tool are desirable, the feed stock can rotate at a different angular velocity than the angular velocity of the tool. A circular geometry for the cross-section of the tool in combination with detached or loosely attached feedstock can result in the deposit material and tool rotating at the same or different velocities. Illustrations of various tool geometries and surface features on the tool are described in more detail below.

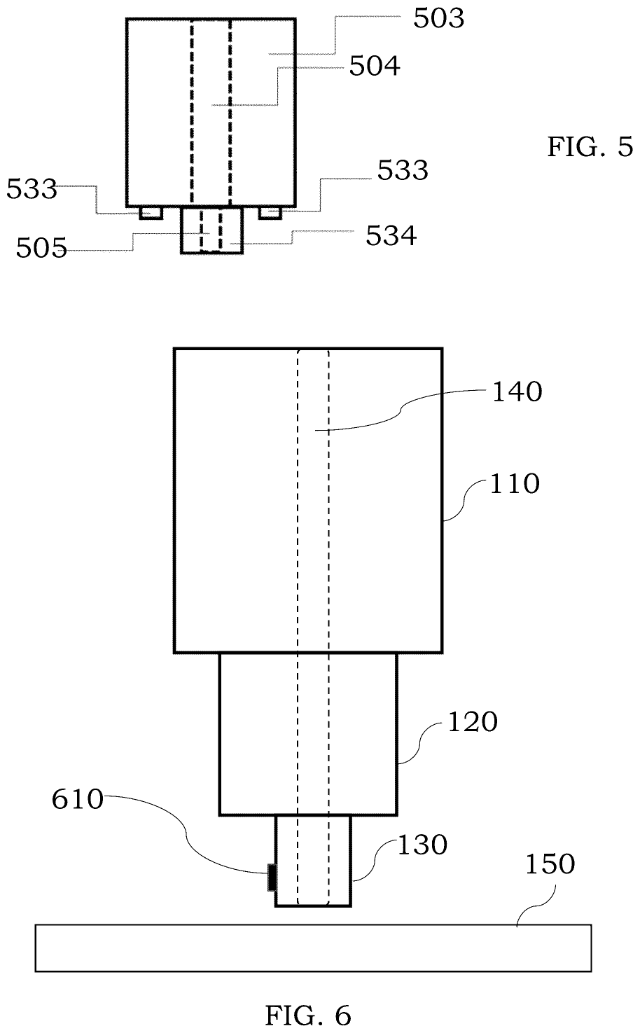

In certain embodiments, a tool can include a shoulder or other geometric features on a surface to assist in depositing the alloy filler material in solid for on a surface of a substrate. For example and referring to FIG. 5, a tool 503 with a throat 504 is shown. A pin 534 with a throat 505 extends from a tool shoulder, where the pin throat 505 is in communication with the tool throat 504. A pin 534 is an optional component of the solid-state additive manufacturing additive manufacturing system. The pin 534 can enable better stirring of the surface region of the workpiece and the alloy filler material. The tool shoulder facing the substrate can include at least one nub 533 made of the same or different material as the tool material. The geometry structures on the tool shoulder may be nubs having various shapes and located in various positions of the tool shoulder for enhancing mechanical stirring of the deposited alloy material. If desired, the nus 533 can be replaceable by an end user, so the nubs can be replaced without needing to replace the entire tool 503. The tool 503 can include one, two, three, four, five, six or more nubs. The nubs can be arranged in a symmetric or asymmetric pattern as desired. The nubs can be solid or hollow and different nubs on a tool may have different shapes, heights, etc. Various tool components are described, for example, in commonly owned U.S. Pat. No. 11,311,959, the entire disclosure of which is incorporated herein by reference.

In certain embodiments, the throat of the spindles and tools described herein may have different lengths, shapes and geometries as desired. For example, the cross-sectional shape of the throat may be square, rectangular, circular, elliptical, oval or other shapes. Further, the cross-sectional shape, diameter, etc. need not be the same from a top edge of the tool to a bottom edge of the tool. The diameter can increase or decrease toward the surface of the tool to be placed adjacent to the substrate.

While not shown the system can also include other suitable components including, but not limited to, gas supplies, external energy sources, ovens, thermocouples, motors, platforms, etc. In certain embodiments, the tool can include, or can be configured to receive, a temperature sensor as shown in FIG. 6. The tool 130 can include a temperature sensor 610, which can be integral to the tool or added separately to the tool 130 and may be present on an external surface of the tool 130 or an internal surface of the tool 130. The sensor 610 can be designed to indirectly monitor the temperature at the surface of the substrate 150 during deposition of the alloy material onto a surface of the substrate. Since it is often difficult to measure the temperature directly at the surface of the substrate 150 during deposition, the temperature sensor 610 can be placed a suitable distance above the surface. As noted in more detail below, a selected temperature window can be used to deposit alloy material, that after heat treatment, has desirable physical and/or mechanical properties. The temperature sensor 610 can include a thermometer, a thermocouple, a resistive temperature measuring device, an optical device, an infrared sensor, a bimetallic device, a change-of-state sensor or other devices which can measure or sense temperature. The sensor 610 can be coupled to the other components in a wired or wireless manner to transmit temperature information to the system. While the exact positioning of the sensor 610 may vary, the sensor 610 is typically located about 0.3 mm to about 0.5 mm above a surface of the substrate 150. The temperature values described herein for producing alloy parts having certain properties refers to the temperature values measured using a sensor similar to the sensor 610 and not necessarily the actual temperature at the interface between the tool 130 and the surface of the substrate 150. The tool temperature can be monitored and selecting, based on measurements from the sensor 610, to deposit the alloy material within a selected tool temperature range.

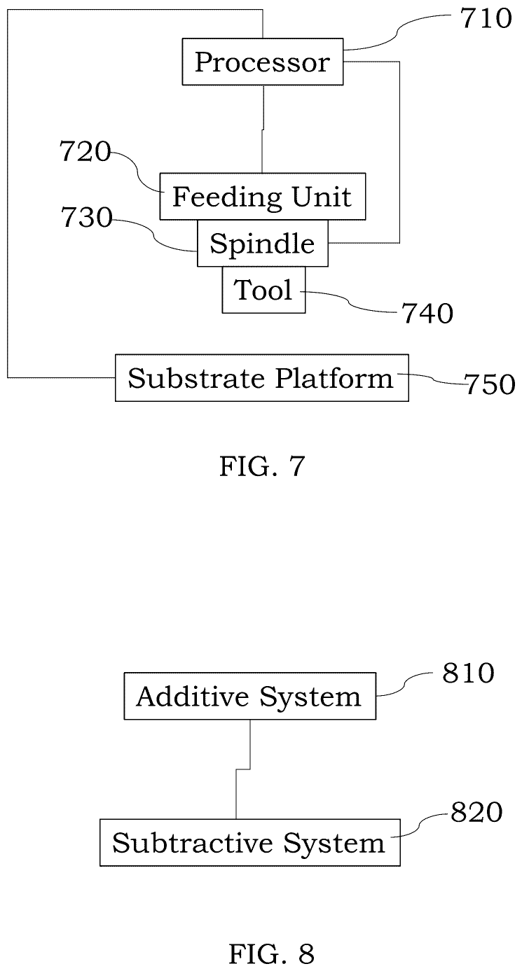

In certain configurations, the various components of the SSA manufacturing system are typically under control using a processor and one or more application software programs. For example and referring to FIG. 7, a block diagram of certain components is shown which can be controlled by a processor of a computer system or a dedicated processor. The system 700 includes a processor 710 electrically coupled to the feeding unit 720, the spindle 730, temperature control devices 740 and a platform 750 configured to receive a substrate. The processor 710 can optionally be coupled to the tool 740 and may also be electrically coupled to a temperature sensor (not shown) with the tool 740. The processor 710 can control one or more of feeding of the alloy material through the feeding unit 720, rotational speed of the spindle 730 to maintain a temperature setpoint, varying the spindle torque to maintain a temperature setpoint, varying the spindle power to maintain a temperature setpoint, varying the deposition rate to maintain a temperature setpoint, varying the tool traverse rate to maintain a temperature setpoint, varying the alloy filler material feed rate to maintain a temperature setpoint, varying the layer height to maintain a temperature setpoint, varying the alloy filler force to maintain a temperature setpoint, varying pressure under the tool 740 to maintain a temperature setpoint, maintaining a temperature setpoint through an external heating source in, around, or near the tool 740, maintaining a temperature setpoint by a source of heat under or around the material being deposited and/or under or around the platform 750, and/or maintaining a temperature setpoint by varying the tool geometry in-situ during production. The processor 710 can also translate the substrate platform 750 to alter its position in the x-, y- or z-dimensions independently of movement of the spindle 730 and/or the tool 740. In a typical use, the substrate platform 750 is moved independently of any movement of the tool 740 during deposition of the alloy filler material onto the substrate platform 750.

The SSA manufacturing system also typically includes a memory unit, storage or other electrical components. The processor 710 can be used, in combination with one or more sensors present in the system to control the various components of the system. Such processes may be performed automatically by the processor without the need for user intervention or a user may enter parameters through a user interface. In certain configurations, the processor may be present in one or more computer systems and/or common hardware circuitry including, for example, a microprocessor and/or suitable software for operating the system. The processor can be integral to the systems or may be present on one or more accessory boards, printed circuit boards or computers electrically coupled to the components of the system. The processor is typically electrically coupled to one or more memory units to receive data from the other components of the system and permit adjustment of the various system parameters and/or control the system components as needed or desired. The processor may be part of a general-purpose computer such as those based on Unix, Intel PENTIUM-type processor, Intel Core™ processors, Intel Xeon™ processsors, AMD Ryzen™ processors, AMD Athlon™ processors, AMD FX™ processors, Motorola PowerPC, Sun UltraSPARC, Hewlett-Packard PA-RISC processors, Apple-designed processors including Apple A12 processor, Apple A11 processor and others or any other type of processor. One or more of any type computer system may be used according to various embodiments of the technology. Further, the system may be connected to a single computer or may be distributed among a plurality of computers attached by a communications network. It should be appreciated that other functions, including network communication, can be performed and the technology is not limited to having any particular function or set of functions. Various aspects may be implemented as specialized software executing in a general-purpose computer system. The computer system may include a processor connected to one or more memory devices, such as a disk drive, memory, or other device for storing data. Memory is typically used for storing programs, authorized users, etc. during operation of the system. Components of the computer system may be coupled by an interconnection device, which may include one or more buses (e.g., between components that are integrated within a same machine) and/or a network (e.g., between components that reside on separate discrete machines). The interconnection device provides for communications (e.g., signals, data, instructions) to be exchanged between components of the system. The computer system typically can receive and/or issue commands within a processing time, e.g., a few milliseconds, a few microseconds or less, to permit rapid control of the system. For example, computer control can be implemented to control the temperature during deposition of the alloy material on the surface of the substrate. The processor typically is electrically coupled to a power source which can, for example, be a direct current source, an alternating current source, a battery, a fuel cell or other power sources or combinations of power sources. The power source can be shared by the other components of the system. The system may also include one or more input devices, for example, a keyboard, mouse, trackball, microphone, touch screen, manual switch (e.g., override switch) and one or more output devices, for example, a printing device, display screen, lights, speaker. The system may contain one or more communication interfaces that connect the computer system to a communication network (in addition or as an alternative to the interconnection device). The system may also include suitable circuitry to convert signals received from the various electrical devices present in the system. Such circuitry can be present on a printed circuit board or may be present on a separate board or device that is electrically coupled to the printed circuit board through a suitable interface, e.g., a serial ATA interface, ISA interface, PCI interface, a USB interface, a Fibre Channel interface, a Firewire interface, a M.2 connector interface, a PCIE interface, a mSATA interface or the like or through one or more wireless interfaces, e.g., Bluetooth, Wi-Fi, Near Field Communication or other wireless protocols and/or interfaces.

In certain embodiments, the system typically comprises a storage system which can be removable and/or can include a non-transitory computer readable medium. The storage system typically includes a computer readable and writeable nonvolatile recording medium in which codes of software can be stored that can be used by a program to be executed by the processor or information stored on or in the medium to be processed by the program. The medium may, for example, be a hard disk, solid state drive or flash memory. The program or instructions to be executed by the processor may be located locally or remotely and can be retrieved by the processor by way of an interconnection mechanism, a communication network or other means as desired. Typically, in operation, the processor causes data to be read from the nonvolatile recording medium into another memory that allows for faster access to the information by the processor than does the medium. This memory is typically a volatile, random access memory such as a dynamic random access memory (DRAM) or static memory (SRAM). It may be located in the storage system or in the memory system. The processor generally manipulates the data within the integrated circuit memory and then copies the data to the medium after processing is completed. A variety of mechanisms are known for managing data movement between the medium and the integrated circuit memory element and the technology is not limited thereto. The technology is also not limited to a particular memory system or storage system. In certain embodiments, the system may also include specially-programmed, special-purpose hardware, for example, an application-specific integrated circuit (ASIC), microprocessor units MPU) or a field programmable gate array (FPGA) or combinations thereof. Aspects of the technology may be implemented in software, hardware or firmware, or any combination thereof. Further, such methods, acts, systems, system elements and components thereof may be implemented as part of the systems described above or as an independent component. Although specific systems are described by way of example as one type of system upon which various aspects of the technology may be practiced, it should be appreciated that aspects are not limited to being implemented on the described system. Various aspects may be practiced on one or more systems having a different architecture or components. The system may comprise a general-purpose computer system that is programmable using a high-level computer programming language. The systems may be also implemented using specially programmed, special purpose hardware. In the systems, the processor is typically a commercially available processor such as the well-known microprocessors available from Intel, AMD, Apple and others. Many other processors are also commercially available. Such a processor usually executes an operating system which may be, for example, the Windows 7, Windows 8 or Windows 10 operating systems available from the Microsoft Corporation, MAC OS X, e.g., Snow Leopard, Lion, Mountain Lion, Mojave, High Sierra, El Capitan or other versions available from Apple, the Solaris operating system available from Sun Microsystems, or UNIX or Linux operating systems available from various sources. Many other operating systems may be used, and in certain embodiments a simple set of commands or instructions may function as the operating system. Further, the processor can be designed as a quantum processor designed to perform one or more functions using one or more qubits. In some instances, a simple set of commands may be present on the computer system, a table or a mobile device that can communicate with the components of the SSA system and can be updated from time to time using one or more wireless or wired connections between the control device and the SSA system.

In certain examples, the processor and operating system may together define a platform for which application programs in high-level programming languages may be written. It should be understood that the technology is not limited to a particular system platform, processor, operating system, or network. Also, it should be apparent to those skilled in the art, given the benefit of this disclosure, that the present technology is not limited to a specific programming language or computer system. Further, it should be appreciated that other appropriate programming languages and other appropriate systems could also be used. In certain examples, the hardware or software can be configured to implement cognitive architecture, neural networks or other suitable implementations. If desired, one or more portions of the computer system may be distributed across one or more computer systems coupled to a communications network. These computer systems also may be general-purpose computer systems. For example, various aspects may be distributed among one or more computer systems configured to provide a service (e.g., servers) to one or more client computers, or to perform an overall task as part of a distributed system. For example, various aspects may be performed on a client-server or multi-tier system that includes components distributed among one or more server systems that perform various functions according to various embodiments. These components may be executable, intermediate (e.g., IL) or interpreted (e.g., Java) code which communicate over a communication network (e.g., the Internet) using a communication protocol (e.g., TCP/IP). It should also be appreciated that the technology is not limited to executing on any particular system or group of systems. Also, it should be appreciated that the technology is not limited to any particular distributed architecture, network, or communication protocol.

In some instances, various embodiments may be programmed using an object-oriented programming language, such as, for example, SQL, SmallTalk, Basic, Java, Javascript, PHP, C++, Ada, Python, iOS/Swift, Ruby on Rails or C #(C-Sharp). Other object-oriented programming languages may also be used. Alternatively, functional, scripting, and/or logical programming languages may be used. Various configurations may be implemented in a non-programmed environment (e.g., documents created in HTML, XML or other format that, when viewed in a window of a browser program, render aspects of a graphical-user interface (GUI) or perform other functions). Certain configurations may be implemented as programmed or non-programmed elements, or any combination thereof. In some instances, the system may comprise a software interface on the SSA system that can receive user input and parameters from a user based on the particular alloy material to be deposited. Instructions and other information and parameters can be entered on SSA system directly through the user interface or indirectly through an interface of an associated mobile device, e.g., tablet, phone, etc., that communicates with the SSA system over a wireless or wired network. The instructions stored in the memory can execute a software module or control routine for the system, which in effect can provide a controllable model of the system to permit deposition of the alloy material in a desired manner.

In certain embodiments, the system can include one or more communications interfaces to permit the SSA system to communicate with other systems or components of the SSA system. For example, the system can include an antenna that may be one or more of a Bluetooth antenna, a cellular antenna, a radio antenna, other antennas or combinations thereof.

In some embodiments, the system can include subtractive components in addition to additive components. For example and referring to FIG. 8, a system can include an additive system 810 and a subtractive system 820. The additive system 810 can be configured as described herein, e.g., to add an aluminum alloy in solid form to a surface of the substrate. The exact nature of the operations provided by the subtractive system 820 can vary. For example, the subtractive system 820 can be configured to provide one or more of grinding, sanding, milling, etc. to remove some of the material which was added to the substrate using the additive system 810. The subtractive system 820 can be used to drill holes or apertures or otherwise machine the final product produced using the additive system 810 into a final part.

### Processes and Process Parameters

As noted herein, a SSA manufacturing system can be used to convert/print the alloy material feedstock into larger or different parts. Without wishing to be bound by any one system, configuration, heat is generated by friction between the tool and the substrate (and in certain cases, if the pin extends from the tool shoulder, the friction is caused by the pin passing through the substrate surface zone). The generated heat provides a significant amount of plastic deformation in the vicinity of the rotating tool (and/or rotating pin, if used). A substantial strain is imparted to the substrate resulting in refinement of its microstructure. The substrate material adjacent to the tool softens and the softened material is mechanically-stirred, and at the same time, mixed and joined with the alloy filler material added via the passageway of the tool using mechanical pressure supplied by the tool shoulder.

In certain configurations, the process can control deposition temperature, i.e. temperature at the interface between the feedstock alloy and either substrate or previously deposited layers by simultaneously controlling key system parameters such as force, pressure, rotation, external heating, external cooling, preheating of substrate, gas flow, ambient temperature, traverse speed, deposition rate, etc. It can be difficult to measure the exact temperature at the feedstock tip that interfaces with the substrate and/or previously deposited material. As in indirect measure or temperature, thermocouples (or other temperature sensing devices) can be located in the tool approximately 0.35 mm above the tip of the tool and filler material. Locating the temperature sensors at other locations might produce different biases versus the actual temperature at the feedstock tip. For example, a smaller gap between feedstock tip and the thermocouple, would be expected to give higher temperature readings for the same actual deposition temperature. Alternatively, laser temperature sensing or other temperature sensing devices could be used instead.

While the exact process temperature can vary for the particular alloy/material used, when the 5000-type alloy material is added to the substrate in a single wall build, good bonding can be achieved when the 5000 alloy is added from a tool at a temperature of 290 deg. Celsius to 500 deg. Celsius, more particularly about 310 deg. Celsius to about 450 deg. Celsius, e.g., from about 325 deg. Celsius to 400 deg. Celsius. The term “single wall” or “single track” refers to the initial layer of alloy material deposited onto the surface of the substrate. If desired, overlapping tracks of alloy material can be added to the single wall build to make a multi-wall build. Overlapping tracks typically permit production of thicker walls and bulkier or larger parts. To achieve good bonding between tracks, it can be desirable to add 10-30 degrees Celsius, 10-20 degrees Celsius or 20-30 degrees Celsius higher temperature setpoints during addition of the second and subsequent tracks onto the single wall or single track. For example, during addition of a second track of 5000 to an already deposited single track of 5000, the deposition temperature range can be from 310 deg. Celsius to 520 deg. Celsius, more particularly 330 deg. Celsius to 470 deg. Celsius, e.g., 345-420 deg. Celsius and is generally higher than the temperature used to deposit the first track on the substrate.

In certain configurations, the exact thickness of any one track may vary from about 0.03 inches to about 0.2 inches, more particularly about 0.04 inches to about 0.18 inches, e.g., 0.05 inches, 0.06 inches, 0.07 inches, 0.08 inches, 0.09 inches, 0.10 inches, 0.11 inches, 0.12 inches, 0.13 inches, 0.14 inches, 0.15 inches, 0.16 inches, or 0.17 inches. Additional tracks can each have a similar thickness as the single track. For example, the thickness of each additional track can vary from about 0.03 inches to about 0.2 inches, more particularly about 0.04 inches to about 0.18 inches, e.g., 0.05 inches, 0.06 inches, 0.07 inches, 0.08 inches, 0.09 inches, 0.10 inches, 0.11 inches, 0.12 inches, 0.13 inches, 0.14 inches, 0.15 inches, 0.16 inches, or 0.17 inches. The percentage of overlap between different tracks may vary from about 5% overlap to about 50% overlap in the x-y direction. For example, adjacent tracks can overlap about 10% to about 40% in the x-y direction, e.g., adjacent tracks can overlap 15%, 20%, 25%, 30%, or 35% in the x-y direction.

In certain embodiments, the temperature control may be accomplished by varying parameters of the system. For example, one or more of the following parameters can be varied to control the temperature: varying the spindle speed to maintain a temperature setpoint, varying the spindle torque to maintain a temperature setpoint, varying the spindle power to maintain a temperature setpoint, varying the deposition rate to maintain a temperature setpoint, varying the tool traverse rate to maintain a temperature setpoint, varying the filler bar feed rate to maintain a temperature setpoint, varying the layer height to maintain a temperature setpoint, varying the filler bar force to maintain a temperature setpoint. varying the pressure under the tool to maintain a temperature setpoint, maintaining a temperature setpoint through an external heating source in, around, or near the tool, maintaining a temperature setpoint by a source of heat under or around the material being deposited, and/or maintaining a temperature setpoint by varying the tool geometry in-situ (during production). Without wishing to be bound by any particular theory, by selecting a suitable temperature range, the overall properties of the deposited alloy material can be improved. For example, at low temperature deposition, the yield strength, ultimate tensile strength and percent elongation of the deposited alloy may be low, e.g., below 100 MPa for the yield strength, below 150 MPa for the ultimate tensile strength, and below 1% elongation. Increasing the temperature to a higher temperature below the melting point of the alloy feedstock material can improve the overall physical properties. In some embodiments, a temperature window is selected so the deposited alloy material has a yield strength of at least 200 MPa, an ultimate tensile strength of at least 250 MPa and a percent elongation of at least 5%. In other configurations, a temperature window is selected so the deposited alloy material has a yield strength of at least 250 MPa, an ultimate tensile strength of at least 275 MPa and a percent elongation of at least 8%. In some configurations, a temperature window is selected so the deposited alloy material has a yield strength of at least 275 MPa, an ultimate tensile strength of at least 300 MPa and a percent elongation of at least 10%. The physical values referred to in this paragraph refer to those values which are present after the deposited material has been subjected to post-deposition heat treatment to temper the deposited alloy material.

In some instances, the temperature can be controlled, at least in part, by selecting or altering spindle speed during deposition. For example, the spindle can be rotated from 150 rpm to about 350 rpm depending on how fast the tooling is moving in the x-y direction. In some examples, spindle rotation rate may vary from about 180 rpm to about 600 rpm, more particularly about 200 rpm to about 280 rpm, e.g., 210 rpm, 220 rpm, 230 rpm, 240 rpm, 250 rpm, 260 rpm, or 270 rpm. The tooling is coupled to the spindle and generally rotates at the same rpm as the spindle. The spindle speed can vary with startup speeds typically being higher than deposition speeds. For example, spindle speed may be 500-600 rpm during startup to increase the surface temperature and then reduced to 180-300 rpm during deposition to assist in maintaining a desired deposition temperature.

In certain embodiments, the exact feed rate of the alloy feedstock material may vary from about 1 inch per minute to about 4 inches per minute, more particularly about 1.5 inches per minute to 3.5 inches per minute, e.g., 1.6 inches per minute, 1.7 inches per minute, 1.8 inches per minute, 1.9 inches per minute, 2.0 inches per minute, 2.1 inches per minute, 2.2 inches per minute, 2.3 inches per minute, 2.4 inches per minute, 2.5 inches per minute, 2.6 inches per minute, 2.7 inches per minute, 2.8 inches per minute, 2.9 inches per minute, or 3.0 inches per minute. The feed rate can be the same or different when depositing single tracks or single walls and overlapping walls. For example, it may be desirable to increase the feed rate during addition of overlapping tracks to increase the temperature at the surface The feed rate can be increased or decreased based on the temperature measurements to maintain a suitable temperature range during the addition process.

In some embodiments, the alloy feedstock material can be coated or sprayed with a lubricant or other material suitable for depositing the alloy material on the substrate. In general, the lubricant can assist in movement of the alloy feedstock material through the hollow passageway of the tooling. Suitable lubricant materials include, but are not limited to, graphite, carbon black, and other forms of carbon. If desired, a metal lubricant can also be used alone or with the carbon based lubricant material. During the addition of the alloy feedstock material, the lubricant coating tends to be pushed toward the outside of the deposited material and can be subsequently removed during the heat treating of the deposited alloy material.

In some configurations, the tooling can be moved horizontally at a desired rate to deposit a desired amount of information onto the substrate. The exact horizontal movement rate may vary from about 2 inches per minute to about 8 inches per minute, more particularly about 3 inches per minute to about 7 inches per minute, e.g., about 3.5 inches per minute, 4 inches per minute, 4.5 inches per minute, 5 inches per minute, 5.5 inches per minute, inches per minute or 6.5 inches per minute.

In certain examples, the substrate can be cleaned or treated prior to deposition of the alloy onto the substrate material. For example, a surface of the substrate can be subjected to machining, sanding, polishing, etching, chemical or physical treatment or other processes to clean the surface of the substrate or alter the surface of the substrate if desired.

In certain embodiments, the additive manufactured aluminum alloy is produced by a method that includes adding an aluminum alloy as a first aluminum alloy layer to a surface of a substrate using an additive manufacturing process comprising a rotating tool, wherein the aluminum alloy is added to the surface of the workpiece in a solid state at a first tool temperature, and heat treating the solid state added first aluminum alloy layer, wherein the added first aluminum alloy layer comprises at least 60% percent by volume of aluminum as equiaxed grains, with aspect ratios less than 2:1, wherein after heat treatment there is minimal void space between metal atoms in the added, heat treated first aluminum alloy layer, and wherein the added, heat treated, first aluminum alloy layer comprises a 5000-type aluminum alloy. The first tool temperature can be between 290 degrees Celsius to 500 degrees Celsius. The first tool temperature can be maintained by one or more of: varying a speed of a spindle coupled to the rotating tool; or varying torque of the spindle coupled to the rotating tool; or varying power of the spindle coupled to the rotating tool; or varying a deposition rate of the added aluminum alloy; or varying a traverse rate of the rotating tool; or varying a filler feed rate into the rotating tool; or varying a layer height; or varying a filler force; or varying a pressure under the rotating tool; or using an external heating/cooling source adjacent to the rotating tool; or using an external heating/cooling source adjacent to the surface of the substrate; or varying a tool geometry during addition.

In some embodiments, a second aluminum alloy layer can be added in the solid state to the added, first aluminum alloy layer using the rotating tool, wherein the second aluminum alloy layer is added using a second tool temperature that is 20 degrees Celsius higher than the first tool temperature. In certain embodiments, after heat treatment of the added second aluminum alloy layer, the added, heat treated second aluminum alloy layer comprises at least 60% percent by volume of aluminum as equiaxed grains, with aspect ratios less than 2:1, wherein there is minimal void space between metal atoms in the added, heat treated second aluminum alloy layer, and wherein the added, heat treated, second aluminum alloy layer comprises 2.0-2.6 weight percent copper, 1.9-2.6 weight percent magnesium, 5.7-6.7 weight percent zinc, 0.08-0.15 weight percent zirconium, no more than 0.7 weight percent of silicon, titanium, chromium, iron or manganese with the remainder being aluminum and incidental impurities to sum to 100 weight percent

In certain configurations, one or more subtractive processes can be performed on the alloy product. For example, a portion of the added first aluminum alloy layer can be removed using a subtractive process to provide a subtracted first aluminum alloy layer on the substrate. The resulting subtracted first aluminum alloy layer can be subjected to heat treatment. The subtracted first aluminum alloy layer comprises at least 60% percent by volume of aluminum as equiaxed grains, with aspect ratios less than 2:1, wherein after heat treatment there is minimal void space between metal atoms in the subtracted, heat treated first aluminum alloy layer, and wherein the subtracted, heat treated, subtracted aluminum alloy layer comprises a 5000-type aluminum alloy as described herein. The first tool temperature can be between 290 degrees Celsius to 500 degrees Celsius. In some embodiments, the first tool temperature is maintained by one or more of: varying a speed of a spindle coupled to the rotating tool; or varying torque of the spindle coupled to the rotating tool; or varying power of the spindle coupled to the rotating tool; or varying a deposition rate of the added aluminum alloy; or varying a traverse rate of the rotating tool; or varying a filler feed rate into the rotating tool; or varying a layer height; or varying a filler force; or varying a pressure under the rotating tool; or using an external heating/cooling source adjacent to the rotating tool; or using an external heating/cooling source adjacent to the surface of the substrate; or varying a tool geometry during addition. A second aluminum alloy layer can be added in the solid state to the subtracted, aluminum alloy layer using the rotating tool, wherein the second aluminum alloy layer is added using a second tool temperature that is 20 degrees Celsius higher than the first tool temperature. In certain embodiments, after heat treatment of the added second aluminum alloy layer, the added, heat treated second aluminum alloy layer comprises at least 60% percent by volume of aluminum as equiaxed grains, with aspect ratios less than 2:1, wherein there is minimal void space between metal atoms in the added, heat treated second aluminum alloy layer, and wherein the added, heat treated, second aluminum alloy layer comprises a 5000-type aluminum alloy as described herein.

In some examples, the final formed layers or tracks can be subjected to post addition treatment including solution treatment, heating or the like. For example, the resulting aluminum alloy can be tempered using similar methods and process conditions commonly used to temper 5000 aluminum alloys. In some embodiments, the formed part can be subjected to solution heat treatment at temperatures from 430 degrees Celsius to 540 degrees Celsius followed by quenching. Since 5000-type series can often form magnesium oxides, post-deposition processes such as annealing may be performed instead of any solution heat treatment. Other heat treatment processes can also be performed depending on the desired temper or other desired physical properties.

### Products and Parts

In certain embodiments, the systems and methods described herein can be used to produce a solid-state additive manufactured product from the alloy material. For example, the alloy product comprises at least 60% percent by volume of aluminum in the additive manufactured aluminum alloy as equiaxed grains, with aspect ratios less than 2:1 after heat treatment of the additive manufactured aluminum alloy. The alloy product comprises minimal void space, similar to other wrought products such as forgings, between metal atoms of the additive manufactured aluminum alloy. The product is a non-extruded, non-rolled and non-forged product comprising the alloy material and can be produced without using any forging dies or extrusion tooling. As noted herein, the microstructure present in the product is sensitive to the production conditions and can be different depending on the temperature and conditions used during production. In some embodiments, the product has a different microstructure than a comparable alloy product produced using forging or extrusion processes.

In certain configurations, the alloy product comprises a solid-state additive manufactured aluminum composition comprising a 5000-type aluminum alloy as described herein. The alloy product can be heat treated to provide a desired temper and/or a desired mechanical and physical properties. For example, in the primary direction of the build, e.g., longitudinal properties in the x-y plane, after solution heat treatment and artificial aging to an overaged condition with an A-rating for stress-corrosion cracking resistance per the criteria in ASTM 64, a SSA manufactured alloy product with an ultimate tensile strength, tensile yield strength, and elongation at break as described herein in reference to the different 5000-type aluminum alloys.

In certain embodiments, the materials and processes described herein can be used to produce large parts and/or parts with multi-dimensional geometries. The technology can be used produce high strength aluminum parts that might otherwise be forged. These types of parts are used in various applications including aerospace, defense and similar critical applications. The parts can be deposited, then machined and heat treated to tempers. There may be a final machining operation to produce the desired geometry and many, if not most of the parts will receive some coating to protect the appearance and prevent corrosion. Certain illustrative parts are described below.

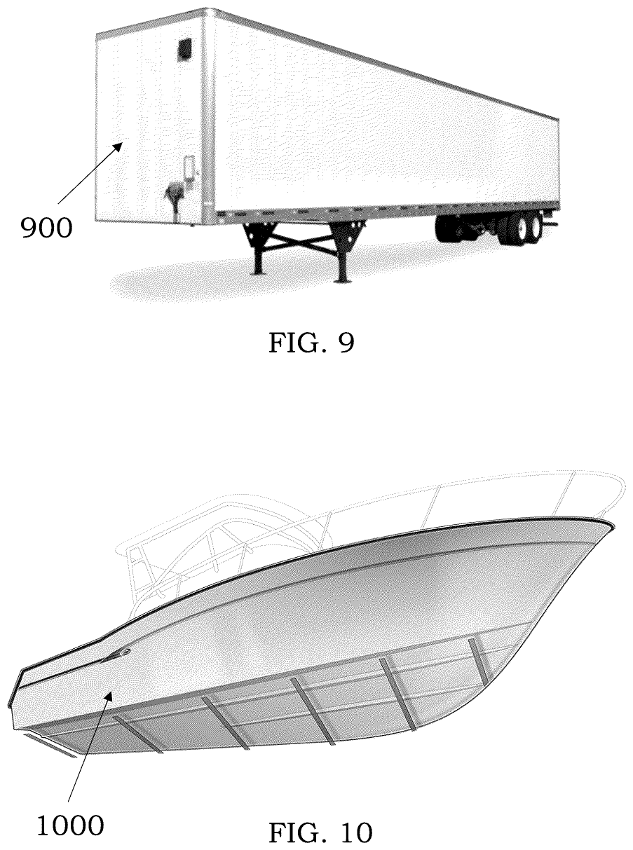

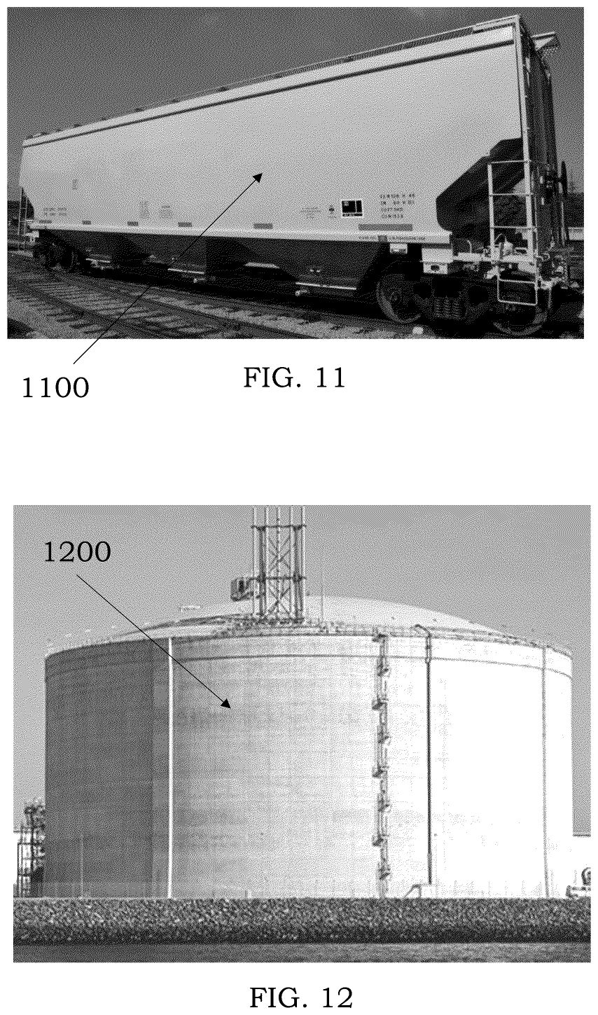

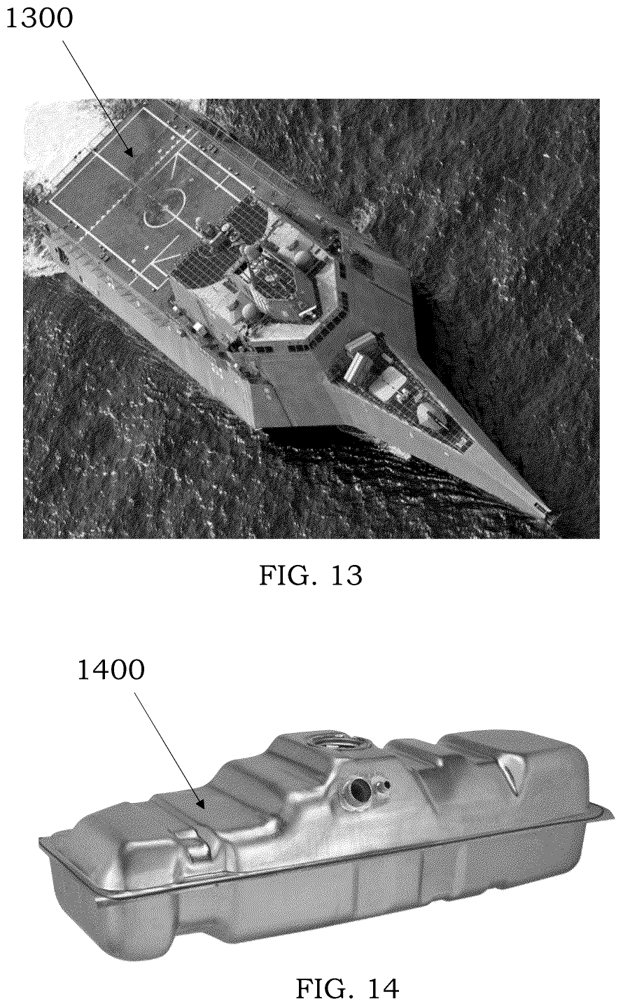

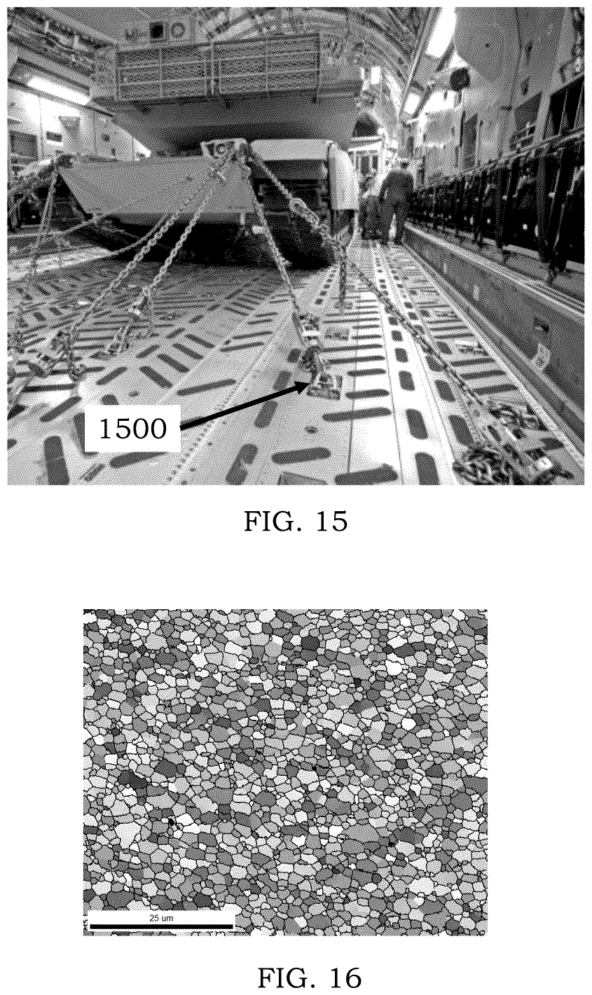

In some configurations, the alloy material products produced by deposition using an SSA system can be used in many land and naval applications. For example, produced parts can be used in marine applications (ladders, docks, decking), truck trailer, automotive sheet, packaging, beverage can, boat hulls, boat decks, LNG tanks, rail car, coal cars, grain cars, fuel tankers, building and construction, heat exchangers, chemical process, and industrial applications. Certain examples are shown in FIGS. 9-12 including a truck trailer 900 (FIG. 9), a boat hull 1000 (FIG. 10), a rail car 1100 (FIG. 11), an LNG tank 1200 (FIG. 12), a ship deck 1300 (FIG. 13), a fuel tank 1400 (FIG. 14), a tie down 1500 (FIG. 15), marine structures such as connectors, nodes and other thick parts, thick components for tractor-trailers, chemical process equipment, stiffeners on beams used in transportation vehicles and other components. The 5000 type alloy can be used to repair cracks or other defects in any of these components as well.

In certain embodiments, the produced parts can include an equiaxial grain structure as shown in FIG. 16. For example, the produced 5000 aluminum alloy product can include equiaxed grains as shown in FIG. 16.

Certain specific examples are described to illustrate further some of the novel aspects and features of the technology described herein.

### Example 1

The 5xxx-series aluminum alloys are commonly used in transportation and marine environments, for applications on ships. One development using this process has been repair of 5083 and other 5xxx decking on ships. These decks can be damaged and also can develop cracks at joints that are designed into the decking. The systems and methods described herein can be used to deposit additional material to both seal the crack and restore the structure to better properties.

To repair the decking, the crack is machined on both sides to produce a smooth, concave opening for deposit. The new 5083 aluminum material is then deposited in a manner that penetrates through deck plate and to the other side ensuring complete bonding. Finally, the deck surface is machined smooth to return to the original contour and provide a reliable surface.

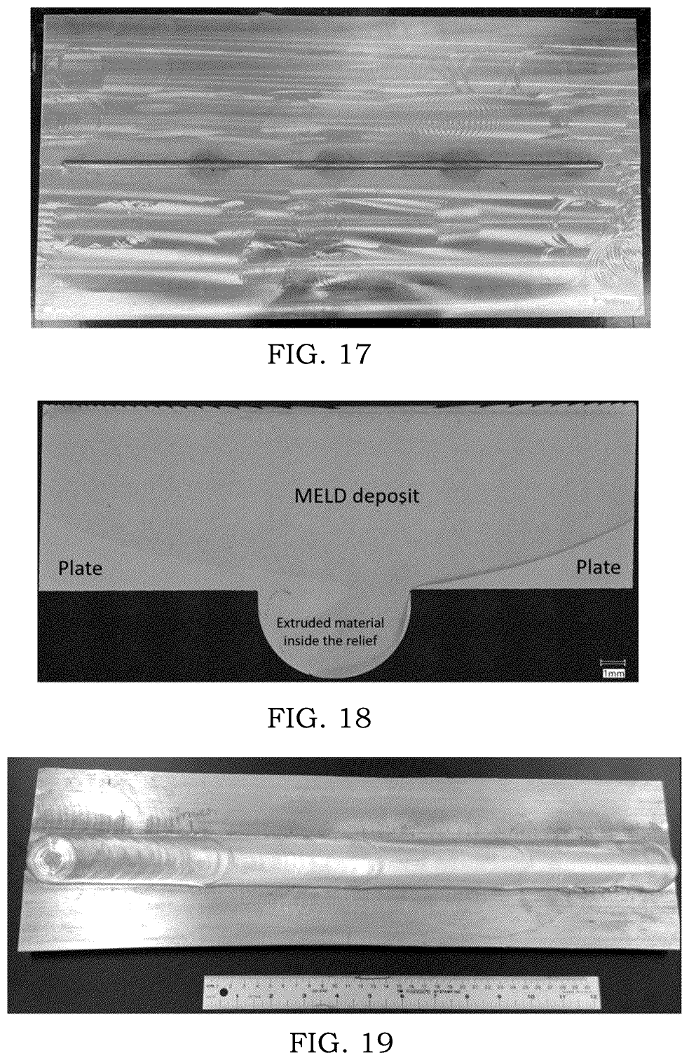

To simulate a crack, a crack can be machined into a plate (see FIG. 17). This crack can be machined in preparation for the repair that will be done by depositing new 5083 aluminum. An illustration showing a cross-section of the repaired area with material extruded through the machined opening into a relief area on the tooling setup of the additive manufacturing equipment is shown in FIG. 18. FIG. 19 shows a repair in the simulated crack shown in FIG. 17. In service, the repaired deck plate is machined smooth prior to reentering service.

When introducing elements of the examples disclosed herein, the articles “a,” “an,” “the” and “said” are intended to mean that there are one or more of the elements. The terms “comprising,” “including” and “having” are intended to be open-ended and mean that there may be additional elements other than the listed elements. It will be recognized by the person of ordinary skill in the art, given the benefit of this disclosure, that various components of the examples can be interchanged or substituted with various components in other examples.

Although certain aspects, examples and embodiments have been described above, it will be recognized by the person of ordinary skill in the art, given the benefit of this disclosure, that additions, substitutions, modifications, and alterations of the disclosed illustrative aspects, examples and embodiments are possible.

1. A solid-state additive manufactured aluminum alloy product, wherein at least 60% percent by volume of the aluminum in the additive manufactured aluminum alloy product are present as equiaxed grains, with aspect ratios less than 2:1, in the additive manufactured aluminum alloy product, wherein there is minimal void space between metal atoms of the additive manufactured aluminum alloy product, and wherein the solid-state additive manufactured aluminum product comprises a 5000-type aluminum alloy.

2-4. (canceled)

5. The solid-state additive manufactured aluminum alloy product of claim 1, wherein the solid-state additive manufactured aluminum alloy product comprises a single track of deposited solid-state additive manufactured aluminum alloy product.

6. The solid-state additive manufactured aluminum alloy product of claim 1, wherein the solid-state additive manufactured aluminum alloy product comprises a plurality of overlapping tracks of deposited solid-state additive manufactured aluminum alloy product.

7. The solid-state additive manufactured aluminum alloy product of claim 6, wherein adjacent tracks overlap by at least 10%.

8. The solid-state additive manufactured aluminum alloy product of claim 1, further comprising a substrate that receives the solid-state additive manufactured aluminum alloy product.

9. The solid-state additive manufactured aluminum alloy product of claim 1, wherein at least 75% percent by volume of the aluminum in the additive manufactured aluminum alloy product are present as equiaxed grains.

10. The solid-state additive manufactured aluminum alloy product of claim 1, wherein at least 90% percent by volume of the aluminum in the additive manufactured aluminum alloy product are present as equiaxed grains.

11. A solid state additive manufactured aluminum alloy produced by adding an aluminum alloy to a surface of a substrate using a solid state additive manufacturing process, wherein the aluminum alloy is added in a solid state as a first aluminum alloy layer to the surface of the substrate at a first tool temperature between 290 degrees Celsius to 500 degrees Celsius, wherein at least 60% percent by volume of aluminum in the added, first aluminum alloy layer are present as equiaxed grains, with aspect ratios less than 2:1, and wherein there is minimal void space between metal atoms in the added, first aluminum alloy layer, and wherein the solid state additive manufactured aluminum alloy comprises a 5000-type aluminum alloy.

12-14. (canceled)

15. The solid-state additive manufactured aluminum alloy of claim 11, wherein the solid-state additive manufactured aluminum alloy comprises a single track of deposited solid-state additive manufactured aluminum alloy.

16. The solid-state additive manufactured aluminum alloy of claim 11, wherein the solid-state additive manufactured aluminum alloy comprises a plurality of overlapping tracks of deposited solid-state additive manufactured aluminum alloy.

17. The solid-state additive manufactured aluminum alloy of claim 16, wherein adjacent tracks overlap by at least 10%.

18. The solid-state additive manufactured aluminum alloy of claim 11, further comprising a substrate that receives the solid-state additive manufactured aluminum alloy.

19. The solid-state additive manufactured aluminum alloy of claim 11, wherein at least 75% percent by volume of the aluminum in the additive manufactured aluminum alloy are present as equiaxed grains.

20. The solid-state additive manufactured aluminum alloy of claim 11, wherein at least 90% percent by volume of the aluminum in the additive manufactured aluminum alloy are present as equiaxed grains.

21. An additive manufacturing system for producing an aluminum alloy product, the additive manufacturing system comprising:
a feeding unit configured to receive an aluminum alloy filler material;
a spindle comprising an internal path configured to receive the aluminum alloy filler material from the feeding unit;
a tool coupled to the spindle and configured to receive the aluminum alloy filler material from the spindle and add the received aluminum alloy filler material to a surface of a substrate in a solid state as a first aluminum alloy layer;
a temperature sensor configured to measure a temperature of the tool during addition of the aluminum alloy filler material as the first aluminum alloy layer to the surface of the workpiece; and
a processor electrically coupled to the temperature sensor and the spindle; and
a computer readable medium electrically coupled to the processor, wherein the computer readable medium has instructions stored thereon, wherein the instructions, when executed by the processor, cause the processor to control movement of the spindle to control a first tool temperature of the tool between 290 degrees Celsius to 500 degrees Celsius during addition of the first aluminum alloy layer to the surface of the substrate, wherein the added first aluminum alloy layer comprises at least 60% percent by volume of aluminum as equiaxed grains, with aspect ratios less than 2:1, wherein there is minimal void space between metal atoms in the added, first aluminum alloy layer, and wherein the added, first aluminum alloy layer comprises a 5000-type aluminum alloy.

22. The additive manufacturing system of claim 21, wherein the processor is configured to increase a temperature of the tool from the first tool temperature to a second tool temperature about 20 degrees Celsius higher than the first tool temperature to add a vertical layer of the aluminum alloy to the added first aluminum alloy layer.

23. The additive manufacturing system of claim 21, wherein the tool comprises tool steel, copper, a copper alloy, tungsten or a tungsten alloy.

24. The additive manufacturing system of claim 24, wherein the tool comprises at least one nub.

25. The additive manufacturing system of claim 24, wherein the feeding unit comprises an actuator to force the aluminum alloy filler material into the spindle and the tool.

26-35. (canceled)
